(19) United States
(12) Patent Application Publication
(10) Pub. No.: US 2026/0212319 A1
(43) Pub. Date: Jul. 23, 2026

(54) Systems and Methods for Forecasting On-Shelf Availability

(71) Applicant: Kenvue Brands LLC, Summit, NJ (US)

(72) Inventors: Rahul Tyagi, Short Hills, NJ (US); Muyeena Akbari Khanzada, Bangalore (IN); Edward N. McGrath, Warrington, PA (US); Sunil Kumar Potnuru, Bengaluru (IN); Aanal N. Shah, Ahmedabad (IN); Biswajit Pal, Bengaluru (IN)

(21) Appl. No.: 19/451,028

(22) Filed: Jan. 16, 2026

Related U.S. Application Data
(60) Provisional application No. 63/747,465, filed on Jan. 21, 2025.

(51) Int. Cl. G06Q 10/087

(52) U.S. Cl. CPC G06Q 10/08726

(57) ABSTRACT

Systems and methods for managing on-shelf availability (OSA) and phantom inventory. The method includes determining a classification for one or more products, generating, based on the determined classification, a day-level forecast for the one or more products, generating, based on the generated day-level forecast, an alert associated with the one or more products, the generated alert indicating an on-shelf availability (OSA) issue with the one or more products, and outputting the generated alert.

### CROSS-REFERENCE TO RELATED APPLICATION

This application claims the benefit of U.S. Provisional Application No. 63/747,465 filed Jan. 21, 2025, the contents of which is incorporated herein by reference in its entirety.

### BACKGROUND

On-shelf availability remains a critical challenge in retail, where delays in restocking or misplaced inventory lead to significant revenue losses despite sufficient stock in stores. Even if the system indicates that there is sufficient stock of an item, customers may not be able to find the product on the shelves. Phantom inventory amplifies on-shelf availability issues by creating a false sense of sufficient stock in the system, leading to unaddressed out-of-stock situations on the shelves.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various implementations of the present disclosure provide systems and methods for managing on-shelf availability (OSA) and phantom inventory. In one example, a computer-implemented method includes determining a classification for one or more products, wherein the classification is determined based on one or more of data sparsity and sales trends; generating, based on the determined classification, a day-level forecast for the classified one or more products; generating, based on the generated day-level forecast, an alert associated with the forecasted one or more products, the generated alert indicating an on-shelf availability (OSA) issue with the one or more products; and outputting the generated alert.

In another example, a system comprises a memory and a processor coupled to the memory. The processor is configured to capture data from one or more structured datasets, wherein the captured data includes at least information associated with the one or more products, the data sparsity, and the sales trends; and pre-process the captured data; determine a classification for one or more products, wherein the classification is determined based on one or more of data sparsity and sales trends; generate, based on the determined classification, a day-level forecast for the classified one or more products; generate, based on the generated day-level forecast, an alert associated with the forecasted one or more products, the generated alert indicating an on-shelf availability (OSA) issue with the one or more products; and output the generated alert.

In another example, one or more non-transitory computer readable media storing instructions that, when executed by a processor, cause the processor to capture data from one or more structured datasets, wherein the captured data includes at least information associated with the one or more products, the data sparsity, and the sales trends; harmonize the captured data into a retailer-specific data schema, wherein the harmonized data includes standardized entities, and wherein the standardized entities include at least one of a point of sale (POS), inventory, or item master; merge the harmonized data with second captured data, the second captured data including at least one of weather data, demographics data, or calendar data; determine a classification for one or more products, wherein the classification is determined based on one or more of data sparsity and sales trends; generate, based on the determined classification, a day-level forecast for the classified one or more products; generate, based on the generated day-level forecast, an alert associated with the forecasted one or more products, the generated alert indicating an on-shelf availability (OSA) issue with the one or more products; and output the generated alert.

### BRIEF DESCRIPTION OF THE DRAWINGS

The present description will be better understood from the following detailed description read in light of the accompanying drawings, wherein:

FIG. 1 illustrates an example system for forecasting on-shelf availability according to an example;

FIG. 2 illustrates an example engine for an on-shelf availability system according to an example;

FIG. 3 illustrates a computer-implemented method of generating an alert for a product in an on-shelf availability forecast system according to an example;

FIG. 4 illustrates a computer-implemented method of pre-processing data for an on-shelf availability forecast system according to an example;

FIG. 5 a graph illustrating true OSA issue percentage over artificial intelligence (AI) systems alerts probability score;

FIG. 6 is a graph illustrating true OSA issues percentage over time with continuous learning;

FIG. 7 is a graph illustrating accuracy comparisons of OSA alert systems;

FIG. 8 is a graph illustrating percentage of OSA issues due to phantom inventory; and

FIG. 9 is a block diagram of an example computing device for implementing aspects disclosed herein.

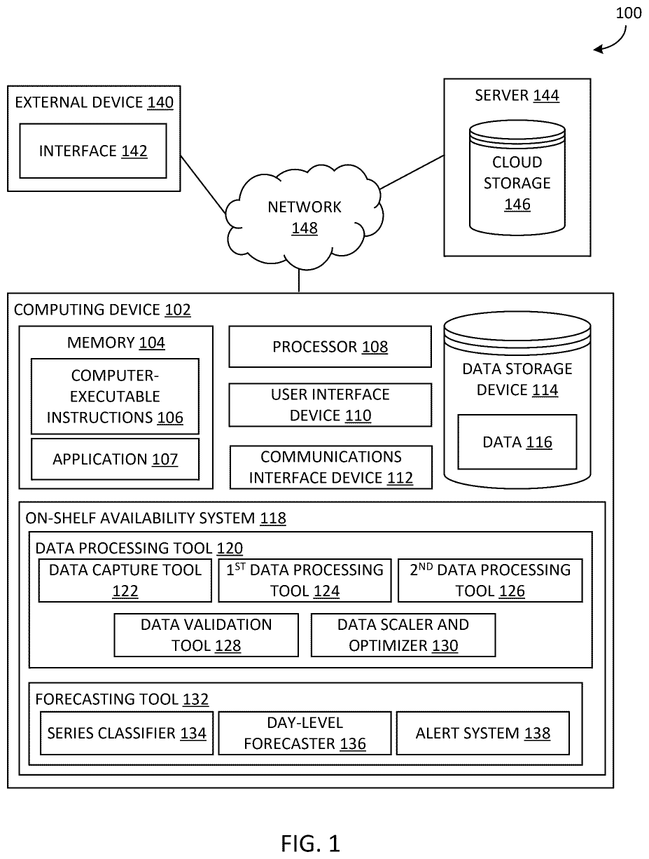

Corresponding reference characters indicate corresponding parts throughout the drawings. In FIGS. 1 to 9, the systems are illustrated as schematic drawings. The drawings may not be to scale.

### DETAILED DESCRIPTION

The various implementations and examples will be described in detail with reference to the accompanying drawings. Wherever possible, the same reference numbers will be used throughout the drawings to refer to the same or like parts. References made throughout this disclosure relating to specific examples and implementations are provided solely for illustrative purposes but, unless indicated to the contrary, are not meant to limit all examples.

As described herein, OSA remains a critical challenge in retail, where delays in restocking or misplaced inventory lead to significant revenue losses despite sufficient stock in stores. Even in instances where an inventory system indicates that there is sufficient stock of an item, customers may not be able to find the product on the shelves due to delays between the item being removed from the shelf and purchased, the item being removed from the shelf but not removed from the inventory system, technical challenges with the inventory system, and so forth. Phantom inventory amplifies on-shelf availability issues by creating a false sense of sufficient stock in the system, leading to unaddressed out-of-stock situations on the shelves.

Various examples described herein provide systems and methods that provide a scalable, artificial intelligence (AI)-powered solution that leverages advanced machine learning (ML) models and distributed cloud processing to address these inefficiencies. The examples disclosed herein integrate a heterogeneous forecasting ensemble of models, ranging from statistical approaches such as exponential smoothing or Autoregressive Integrated Moving Average (ARIMA) to machine learning techniques such as eXtreme Gradient Boosting (XGBoost) and the implementation of neural networks. Some examples further include an adaptive alert fusion system that integrates priority alerts, random alerts and those generated by ML algorithms such as XGBoost, which analyze operational data, including stock-in-transit, shelf capacities, and store layouts, to detect and flag potential disruptions in shelf availability and phantom inventory. Targeted alerts generated by this framework enable field brokers to investigate, resolve, and provide feedback, creating a continuous improvement loop that enhances system accuracy and adaptability. Built on distributed cloud platforms, the architecture processes high-velocity, heterogeneous datasets from thousands of stores using scalable compute clusters and automated ML retraining pipelines. Insights into key metrics, such as lost sales, Out of Stock (OOS) due to phantom inventory, and on-shelf availability scores, are delivered through advanced visualization tools, enabling timely and strategic interventions. In some examples, the system is used further to improve store inventory planning parameters such as safety stock, ordering policy, and delivery frequency. Early detection of phantom inventory may mitigate the whiplash effect in the upstream supply chain by providing leading signals for inventory anomalies. This advanced system redefines on-shelf availability and inventory management, transforming it into a proactive, scalable, and efficient solution that maximizes revenue potential and operational performance across expansive retail networks.

As referenced herein, OSA refers to the extent to which products are available for customers to purchase in the right quantities and at the right location. OSA measures the alignment between supply chain processes and consumer demand. As referenced herein, phantom inventory refers to the discrepancy where inventory is recorded as available in the system but is either misplaced, damaged, or otherwise not physically present on the shelf for customer purchase. The mismatch resulting from phantom inventory creates an illusion of adequate stock levels while leading to missed sales opportunities. Ensuring high OSA and minimizing phantom inventory is critical for retailers and manufacturers alike in several areas. For example, unavailable products lead to lost sales and diminished brand loyalty which decreases customer satisfaction, accurate inventory data helps with effective supply chain planning and reduces carrying costs to improve operational efficiency, poor OSA is estimated to result in millions of dollars in annual lost revenue due to stockouts and unmet customer demand, and frequent unavailability of products affects customer trust and competitiveness in the market.

Current solutions rely on periodic manual audits where store employees conduct physical inventory checks to match actual stock with system records, reorder point systems that trigger replenishment orders based on predefined thresholds, and vendor-managed inventory (VMI) where suppliers monitor and replenish stock levels based on agreed-upon metrics. While these methods offer some control over stock management, they are often labor-intensive, error-prone, and lack real-time insights.

The systems and methods of the present disclosure recognize these challenges and provide a novel AI-driven system designed to address the complexities of demand forecasting and inventory management. This approach employs advanced ML models to analyze historical sales data, seasonal trends, and various external factors, including weather and promotional events. By doing so, this system predicts demand with improved accuracy. Some examples of the present disclosure further include an adaptive alert fusion system that integrates priority alerts, random alerts alongside those generated by ML algorithms, such as XGBoost. This system analyzes operational data, including stock-in-transit, shelf capacities, and store layouts to identify and flag potential disruptions related to shelf availability and phantom inventory. To enhance the practicality and effectiveness of our solution, the system is integrated to seamlessly work across different field broker systems. The system maximizes the efficiency of field brokers in store time by prioritizing the alerts with high-impact OSA and phantom inventory issues to be resolved, investigating discrepancies, and providing feedback. The continuous feedback loop not only helps in resolving immediate problems but also contributes to the ongoing improvement of the system's accuracy and adaptability. By combining these advanced techniques, the present disclosure offers a comprehensive solution that enhances demand forecasting and inventory management processes, leading to more efficient retail operations.

The systems and methods of the present disclosure operate in an unconventional manner by combining multiple ML models to accurately predict demand of a particular item, adaptively generate alerts, and utilize operational data to determine disruptions that affect OSA and phantom inventory. The systems and method further receive feedback in a feedback loop that enables continuous improvement of the models, resulting in a comprehensive solution that enhances demand forecasting and inventory management processes, leading to more efficient retail operations.

The systems and methods of the present disclosure provide a technical solution to the technical problem of inventory management systems failing to accurately account for inventory items that are listed in the inventory system as in stock but not actually available. The systems and methods of the present disclosure implements multiple ML models to accurately predict demand of a particular item, adaptively generate alerts, and utilize operational data to determine disruptions that affect OSA and phantom inventory. Accordingly, the present disclosure provides a more accurate representation of available inventory items as well as a continuous monitoring and updating process for the ML models.

As described herein, the OSA system employs a robust machine learning (ML) operations and platform strategy, ensuring scalable, reliable, and efficient AI operations. Key principles such as automation, modularity, and monitoring are integrated into each stage of the model lifecycle to enhance productivity and reduce time to market. Core components of the strategy include Continuous Integration and Continuous Deployment (CI/CD) integration, automated retraining pipelines, feature store management, and monitoring and metrics. CI/CD integration may be powered by tools such as Jenkins and Databricks Asset Bundles (DABs) and enable seamless deployment and version control. These pipelines include automated integration, unit testing, and rollback mechanisms to maintain system stability during updates. Automated retraining pipelines is triggered by data drift detection, these pipelines retrain models using the latest data, ensuring the models adapt to changing market conditions. Feature store management refers to the adoption of a centralized feature store enables consistency across training and inferencing, promoting reusability and alignment in feature engineering. Monitoring and metrics includes tools like MLFlow monitor model performance and data quality, ensuring 99.9% accuracy consistency across environments. Drift detection and anomaly detection systems may proactively flag issues.

FIG. 1 illustrates an example system for forecasting on-shelf availability according to an example. The system 100 illustrated in FIG. 1 is provided for illustration only. Other examples of the system 100 can be used without departing from the scope of the present disclosure.

The system 100 includes a computing device 102, an external device 140, a server 144, and a network 148. The computing device 102 represents any device executing computer-executable instructions 106 (e.g., as application programs, operating system functionality, or both) to implement the operations and functionality associated with the computing device 102. The computing device 102 in some examples includes a mobile computing device or any other portable device. A mobile computing device includes, for example but without limitation, a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

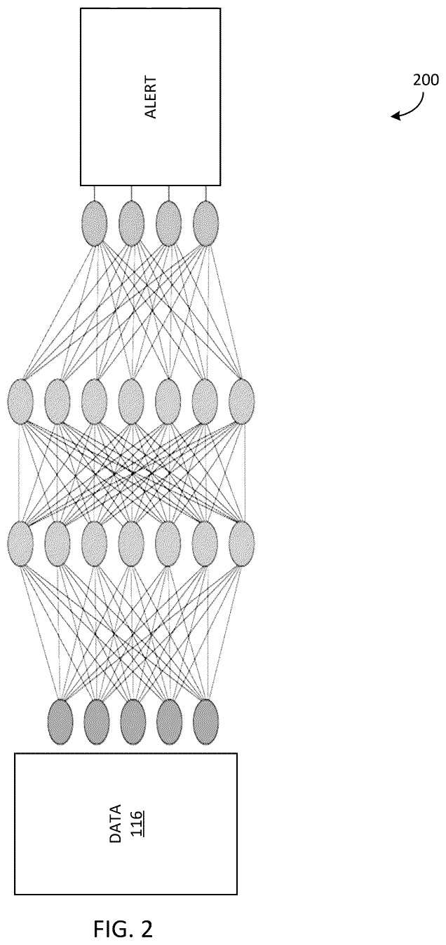

In some examples, the computing device 102 includes at least one processor 108, a memory 104 that includes the computer-executable instructions 106, and a user interface device 110. The processor 108 includes any quantity of processing units and is programmed to execute the computer-executable instructions 106. The computer-executable instructions 106 are performed by the processor 108, performed by multiple processors within the computing device 102, or performed by a processor external to the computing device 102. In some examples, the processor 108 is programmed to execute computer-executable instructions 106 such as those illustrated in the figures described herein, such as FIGS. 2-8. In various examples, the processor 108 is configured to execute computer-executable instructions of an on-shelf availability (OSA) system 118 as described herein.

The memory 104 includes any quantity of media associated with or accessible by the computing device 102. In some examples, the memory 104 is internal to the computing device 102. In other examples, the memory 104 is external to the computing device 102 or both internal and external to the computing device 102. For example, the memory 104 can include both a memory component internal to the computing device 102 and a memory component external to the computing device 102, such as the server 144. The memory 104 stores data, such as one or more applications 107. The applications 107, when executed by the processor 108, operate to perform various functions on the computing device 102. The applications 107 can communicate with counterpart applications or services, such as web services accessible via the network 148. In an example, the applications 107 represent server-side services of an application executing in a cloud, such as a cloud server 144. In some examples, the application 107 is an application for determining OSA and/or phantom inventory as described herein.

The user interface device 110 includes a graphics card for displaying data to a user and receiving data from the user. The user interface device 110 can also include computer-executable instructions, for example a driver, for operating the graphics card. Further, the user interface device 110 can include a display, for example a touch screen display or natural user interface, and/or computer-executable instructions, for example a driver, for operating the display. The user interface device 110 can also include one or more of the following to provide data to the user or receive data from the user: speakers, a sound card, a camera, a microphone, a vibration motor, one or more accelerometers, a BLUETOOTH® communication module, global positioning system (GPS) hardware, and a photoreceptive light sensor. In a non-limiting example, the user inputs commands or manipulates data by moving the computing device 102 in one or more ways.

The computing device 102 further includes a communications interface device 112. The communications interface device 112 includes a network interface card and/or computer-executable instructions, such as a driver, for operating the network interface card. Communication between the computing device 102 and other devices, such as but not limited to the external device 140, can occur using any protocol or mechanism over any wired or wireless connection.

The computing device 102 further includes a data storage device 114 for storing data 116. The data 116 includes, but is not limited to, one or more types of one or both of structured and unstructured data. For example, the data 116 includes, but is not limited to, one or more structured datasets associated with products, data scarcity, and sales trends that are obtained from one or more APIs, cloud shares, secure FTP, and email attachments (formats like JSON, XML, and CSV), as well as external datasets including additional data such as weather, demographics, and holiday calendars. Product data may include sales data, inventory data, shipping data, promotional data, and so forth on a national level, state level, city or county level, and/or store level.

In some examples, the data storage device 114 is an example of an aggregated data storage and retrieval system that includes data from systems that are both internal to the system 100 and external to the system 100. This example of the data storage device 114 is a domain agnostic system that enables improved question and answer quality and enhances productivity by providing direct access to information within a domain or subject matter and, in examples where integrated with an application 107 accessed via the user interface device 110 or interface 142, improves information retrieval of various examples of the data 116. In some examples, an analogous but external data storage device 146 is stored on the server 144. The external data storage device 146 may be another example of the data storage device 114 and storing at least some of the same or similar data 116 as the data storage device 114.

The computing device 102 further includes an on-shelf availability system 118. The system 118 is an example of a specialized processor or processing unit implemented on the processor 108. In some examples, the on-shelf availability system 118 measures and captures results in terms of sales uplift using a structured framework of KPIs. Central to this framework is an Out-of-Stock (OOS) Resolution Window, a defined time period during which a retailer resolves discrepancies in on-hand quantities through scan-outs. This serves as the benchmark for the on-shelf availability system 118 key performance indicators (KPIs) that include lost sales opportunities, lost sales, and recovered sales. Lost Sales Opportunities is calculated by Equation 1 below. represent the sum of the forecasted sales for the OOS Resolution Window. This serves as the worst-case scenario for missed sales due to poor shelf conditions. Lost Sales is calculated as the difference between actual and predicted sales during the OOS Resolution Window when the store-item combination is flagged as an alert. Recovered Sales reflects the sum of actual sales post-positive intervention for the remaining OOS Resolution Window, highlighting the effectiveness of corrective actions.

$${\sum }_{t}^{OOS Resolution Window} Lost Sales Opportunity = {\sum }_{0}^{{t}_{resolution}} Lost Sales + {\sum }_{{t}_{resolution}}^{OOS Resolution Window} Recovered Sales \qquad Equation 1$$

KPIs guide the on-shelf availability system 118 in reprioritizing alerts by combining the probability of a successful intervention with the expected return or Lost Sales Opportunity. This iterative reprioritization ensures that field representatives focus on the most impactful interventions, optimizing outcomes for both manufacturers and retailers. Recovered sales are directly considered incremental and inform strategic allocation of field broker support. In some examples, the on-shelf availability system 118 generates a robust dataset for identifying systemic issues within the retailer ecosystem, leveraging market observations to drive continuous improvement.

The on-shelf availability system 118 includes a data processing tool 120 and a forecasting tool 132. The data processing tool 120 further includes a data capture tool 122, a first data processing tool 124, a second data processing tool 126, a data validation tool 128, and a data scaler and optimizer 130 to capture data and perform pre-processing of the captured data for analysis by the forecasting tool 132. Each of the data capture tool 122, first data processing tool 124, second data processing tool 126, data validation tool 128, and the data scaler and optimizer 130 are further examples of specialized processing units implemented on the data processing tool 120. The forecasting tool 132 further includes a series classifier 134, a day-level forecaster 136, and an alert system 138 to forecast on-shelf availability of products and, where the forecasted availability is below a threshold, generate an alert. Each of the series classifier 134, day-level forecaster 136, and the alert system 138 are further examples of specialized processing units implemented on the data processing tool 120.

The data capture tool 122 captures data 116. The captured data includes at least information associated with one or more products, data sparsity, or sales trends. As referenced herein, the data 116 is captured from one or more structured datasets associated with products, data scarcity, and sales trends that are obtained from one or more APIs, cloud shares, secure FTP, and email attachments (formats like JSON, XML, and CSV), as well as external datasets including additional data such as weather, demographics, and holiday calendars. Product data may include sales data, inventory data, shipping data, promotional data, and so forth on a national level, state level, city or county level, and/or store level. In some examples, the data capture tool 122 stores the captured data 116 in a data lake in the data storage device 114. The data lake serves as an immutable staging area, maintains data fidelity, lineage, and atomicity, consistency, isolation, and durability (ACID) compliance for reliable downstream transformation.

The first data processing tool 124 performs pre-processing of the captured data. The first data processing tool 124 harmonizes the captured data into a retailer-specific data schema. For example, the harmonized data includes standardized entities that themselves include at least one of a point of sale (POS), inventory, or item master. This enables flexibility while preserving retailer granularity for tailored downstream processes. In some examples, the first data processing tool 124 is referred to as a harmonization tool or a harmonization layer.

The second data processing tool 126 performs further pre-processing of the harmonized data. For example, the second data processing tool 126 merges, or consolidates, the harmonized data with additional captured data, also referred to herein as second captured data. The additional captured data includes at least one of weather data, demographics data, or calendar data. In some examples, the consolidation occurs at the country level to provide broader context for regional analysis. In other examples, the consolidation occurs at the regional, state, or store level. Accordingly, the metadata-driven design of the second data processing tool 126 enables flexible, reusable data models that enhance scalability and performance. In some examples, the second data processing tool 126 implements a common data model (CDM).

The data validation tool 128 further pre-processes the consolidated data by incrementally validating the merged data to detect data discrepancies, historically validating the merged data to determine long-term data trends, and aggregating, at a regular interval, newly available data and flagging the aggregated data with a tag. Incremental validation enables early detection of data discrepancies to prevent propagation of errors. Historical validation enables consistency of long-term data trends for accurate analysis. In some examples, data aggregation is performed at a weekly level and enriched with business-specific flags, simplifying downstream processing for machine learning models and business intelligence tools.

The data scaler and optimizer 130 further pre-processes the validated, or aggregated, data by clustering the aggregated data. In some examples, clusters are automatically scaled to manage large data volumes dynamically, ensuring cost-efficient performance, while event-driven processing enables asynchronous data handling for retailer-specific pipelines. In some examples, the pushing down of queries and liquid clustering improve query efficiency.

The series classifier 134 determines a classification for the one or more products. In some examples, the series classifier 134 places each product, of the one or more products, into a category based on the amount of data available for the product. In some examples, the series classifier 134 implements series classification, which classifies a diverse portfolio of products into categories to enhance sales volume forecasting accuracy and robustness. Given the variability in historical sales data, this classification strategy addresses data sparsity and sales trends. The implementation of series classification enables the various models to capture patterns in similar product groups. This augments limited historical data and enables targeted modeling for diverse products and helps optimize computational and analytical resources and streamlines the modeling process.

In various examples, the category is selected from a first category comprising products with a first level of weekly data that is modeled at an item-store level, a second category comprising products with a second level of weekly data, less than the first level of data, that is modeled at a sub-category store level, a third category comprising product with a third level of data, less than the second level of data, that is modeled at a category store level, a fourth category comprising product with a fourth level of data, less than the third level of data, modeled at a category national level, a fifth category comprising products with a fifth level of weekly data, less than the fourth level of data, and a sixth category comprising products that are new with a sixth level of data, less than the fifth level of weekly data.

In some examples, the first category is referred to as a gold category and includes products with sufficient weekly data and modelled at the item-store level.

$$Gold = p \vert ( SalesWeeks ( p , s ) \geq {T}_{Gold} ⋂ LaunchDate ( p , s ) \geq ( {t}_{Gold} ) ⋂ ( AvgRevenue ( p , s ) \geq {R}_{Gold} )$$

In some examples, the second category is referred to as a silver category and includes products with moderate data modeled data the subcategory-store level.

$$Silver = p \vert ( SalesWeeks ( c , s ) \geq {T}_{Silver} ⋂ LaunchDate ( p , s ) \geq ( {t}_{Silver} ) ⋂ AvgRevenue ( c , s ) \geq {R}_{Silver} ⋂ ( p ∉ Gold ) )$$

In some examples, the third category is referred to as a bronze category and includes products with less data and modeled at the category-store level.

$$Bronze = p \vert ( SalesWeeks ( C , s ) \geq {T}_{Bronze} ⋂ LaunchDate ( p , s ) \geq ( {t}_{Bronze} ) ⋂ AvgRevenue ( C , s ) \geq {R}_{Bronse} ⋂ ( p ∉ Gold ⋃ Silver ) )$$

In some examples, the fourth category is referred to as a bronze-national category and includes products with sparse data and modeled at the category-national level.

$$Bronze National = p \vert ( SalesWeeks ( C , N ) \geq {T}_{Bronse National} ⋂ LaunchDate ( p , s ) \geq ( {t}_{Bronze National} ) ⋂ AvgRevenue ( C , N ) \geq {R}_{Bronze National} ⋂ n ( p ∉ Gold ⋃ Silver ⋃ Bronze ) )$$

In some examples, the fifth category is referred to as a low value series category and includes sparse data.

$$Low Value = p \vert ( LaunchDate ( p ) \leq ( {t}_{Bronze National} ) ⋂ AvgRevenue ( p ) < {R}_{Low Value} ⋂ ( p ∉ Gold ⋃ Silver ⋃ Bronze ⋃ Bronze National ) )$$

In some examples, the sixth category is referred to as a new series and includes newly introduced products with little data available, such as a few months.

$$New Series = p \vert ( LaunchDate ( p ) \leq ( {t}_{New Series} ) )$$

$$where ,$$

$$1. SalesWeeks ( x , y ) = \frac{{\sum }_{w = 1}^{W} \text{?} ( Sales ( x , y , w ) > 0 )}{W}$$

$$2. Sales ( x , y , w ) = Sales during week ( w ) of level x ∈ \{ p , c , C ] and$$

$$level y ∈ ( s , N )$$

$$3. \text{?} ( \cdot ) = Indicator function$$

$$4. W = Total weeks in the period$$

$$5. p , c , C represents product , subcategory and Category respectively .$$

$$6. s , N represents store and National level respectively .$$

$$7. {T}_{z} , {t}_{z} , {R}_{z} represents fill rate , time , revenue thresholds of corresponding$$

$$series class z .$$

The day-level forecaster 136 generates day-level forecasts through automated processes based on the diverse needs of different products. The day-level forecaster 136 combines a variety of forecasting models and precise apportioning logic to ensure reliability and precision. The day-level forecaster 136 adeptly manages various sales patterns, seasonality, and trends by applying tailored models and customized feature engineering to each product category, significantly enhancing predictive capabilities. Forecasted values enable the creation of a measurement framework for different KPIs and may be used as guiding values to create rule-based alert systems, such as those implemented by the alert system 138 described below, to collect labels initially before building ML-based alert systems.

In some examples, the day-level forecaster 136 implements feature engineering. Feature engineering transforms raw data into meaningful features, addressing missing values, outliers, inconsistencies, and enriching data with time-based variables and trends. The forecasting factory employs a diverse range of models, including but not limited to univariate models, Elastic Net, XGBoost, Prophet, SARIMAX, DeepAR, LSTM, and Temporal Fusion Transformers, capturing complex data patterns and dependencies. Hyperparameter tuning through Bayesian optimization and an ensemble approach that combines forecasts from multiple models improve accuracy and robustness. Apportioning logic converts higher granularity forecasts into day-level predictions, ensuring alignment with overall trends and variations.

In some examples, the day-level forecaster 136 further implements continuous monitoring and feedback loops. The continuous monitoring and feedback loops enable adaptability and accuracy over time, and further enable the day-level forecaster 136 to anticipate future trends and manage the complexities of various product markets. The advanced models, feature engineering, and ongoing optimization of the day-level forecaster 136 deliver highly accurate and reliable day-level forecasts to navigate and excel in diverse market environments.

The alert system 138 is an adaptable fusion alert system that integrates random alerts, high-priority alerts, and machine learning (ML)-based alerts to identify potential out-of-stock (OSA) issues with store items. The alert system 138 alerts a retailer to proactively prevent stockouts and enhance inventory management. The alert system 138 implements advanced algorithms that analyze a diverse range of data points to generate accurate and timely alerts. By leveraging comprehensive datasets listed in Table 1, the alert system 138 provides a holistic view of inventory status and predicts potential OSA problems before they impact store operations.

TABLE 1
Dataset

| Feature Category | Description |
|---|---|
| Inventory Levels | Current stock levels of items in the store, stock |
| | currently in transit from distribution centers, |
| | Stock ordered by retailers |
| Sales Trends | Historical sales data and trends over time |
| Seasonal Factors | Seasonal variations affecting sales and |
| | inventory needs, holidays |
| Promotional Activities | Historical, ongoing, or upcoming promotions. |
| Shelf Space | Availability and allocation of shelf space for |
| | various products |
| Product Categories | Various categories of products and their |
| | specific inventory requirements |
| Demographics | Customers demographics across geographical |
| | locations |
| Lead Time | Time taken to deliver stock to the store from |
| | distribution center |
| Restocking Frequency | Frequency at which items are re-stocked in the |
| | store by the retailer |
| Historical Alerts | Historical alerts and their outcomes to improve |
| | future predictions |

Accordingly, the systems and methods described herein provide the advantage of being capable of generating diverse types of alerts for various scenarios. Random alerts ensure collecting an unbiased sample of data along with regular and systematic inventory checks across all store items, while high-priority alerts address scenarios of immediate business priority and impact. These alerts prompt swift action to replenish inventory and prevent customer dissatisfaction. The ML-based alerts of the alert system 138, utilizing machine learning algorithms such as, but not limited to, the Spark version of XGBoost, efficiently handles large datasets to identify complex patterns and correlations within the data. The alert system 138 analyzes historical sales trends, seasonality, promotional impacts, and forecasted demand, along with delivery schedules and lead times, to predict when inventory levels might drop below critical thresholds. Various examples of the important feature categories are listed in Table 1 above.

The ML-based alerts of the alert system 138 are continuously refined through feedback loops, enhancing predictive accuracy over time. The alert system 138 tracks the effectiveness of previous alert responses and adjusts its parameters based on this information. This adaptive learning capability enables the alerts to be generated are both relevant and actionable. In some examples, input from field brokers lead to direct action to restock shelves, correct mislabeled products, and address other issues. These inputs provide detailed responses, helping improve the system's accuracy and effectiveness. Sample responses from field brokers may be selected from a list including, but not limited to, Confirmed On Hand Discrepancy, Restocked from backroom or top stock, Confirmed out of stock—inventory in transit, Confirmed out of stock—Requested Manual Order, Item on shelf, Plug Fixed (Wrong item in location), or Printed shelf tag.

Accordingly, the on-shelf availability system 118 addresses the challenges with current solutions described herein through the combination of random, high-priority, and ML-based alerts, to offer a comprehensive and proactive approach to identifying potential OSA issues. The algorithms of the on-shelf availability system 118 enable timely interventions, while adaptive learning ensures continuous improvement. Thus, the alert system 138 empowers retailers to maintain optimal shelf availability, enhance customer satisfaction, and drive sales growth in an increasingly competitive market.

In some examples, the system 118 is further leveraged to identify phantom inventory. As referenced herein, phantom inventory refers to discrepancies between recorded system inventory and actual physical inventory, leading to stockouts and affecting OSA. Identifying phantom inventory is critical for maintaining accurate inventory records and ensuring product availability. Inputs received, such as field broker responses, received for the alerts generated by the alert system 138 discussed herein, initially designed for OSA alerts, can be leveraged to detect phantom inventory cases. These field broker reports often mark products as out-of-stock (OOS) as listed in the sample responses Table 2 despite non-zero system inventory, indicating potential mismatches.

The external device 140 is another example of a computing device, separate from and external of the computing device 102. In some examples, the external device 140 includes a mobile computing device or any other portable device. A mobile computing device includes, for example but without limitation, a mobile telephone, laptop, tablet, computing pad, netbook, gaming device, and/or portable media player. The external device 140 can also include less-portable devices such as servers, desktop personal computers, kiosks, or tabletop devices. Additionally, the external device 140 can represent a group of processing units or other computing devices. The external device 140 includes an interface 142. The interface 142 may be another example of the user interface device 110.

FIG. 2 illustrates an example engine for an on-shelf availability system according to an example. The example engine 200 is presented for illustration only and should not be construed as limiting. Various examples of the engine 200 may be without departing from the scope of the present disclosure. In some examples, the example engine 200 is an example of the on-shelf availability system 118 described herein.

As described herein, the engine 200 generates an alert for a retailer to proactively prevent stockouts and enhance inventory management. The engine 200 includes a plurality of nodes that are traversed based on the input received. As referenced herein, various examples of inputs the engine 200 receives and uses include, but are not limited to, data 116 captured by the data capture tool 122 and stored in the data storage device 114. As referenced herein, examples of the data 116 include, but is not limited to, the data 116 includes, but is not limited to, one or more structured datasets associated with products, data scarcity, and sales trends that are obtained from one or more APIs, cloud shares, secure FTP, and email attachments (formats like JSON, XML, and CSV), as well as external datasets including additional data such as weather, demographics, and holiday calendars. Product data may include sales data, inventory data, shipping data, promotional data, and so forth on a national level, state level, city or county level, and/or store level.

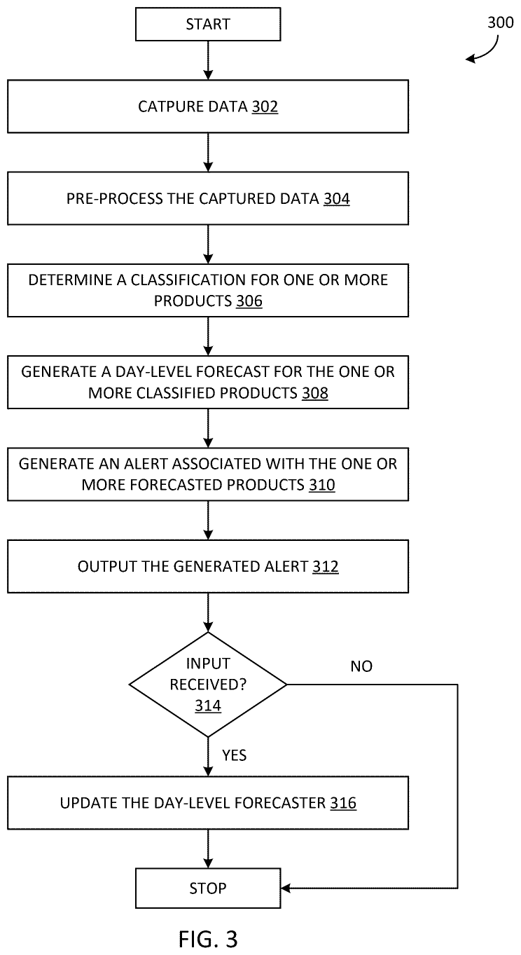

FIG. 3 illustrates a computer-implemented method of generating an alert for a product in an on-shelf availability forecast system according to an example. The computer-implemented method 300 is presented for illustration only and should not be construed as limiting. Other examples of the computer-implemented method 300 can be used without departing from the scope of the present disclosure. The computer-implemented method 300 can be implemented by one or more electronic devices described herein, such as the computing device 102.

The computer-implemented method 300 begins by the data capture tool 122 capturing data in operation 302. The captured data includes at least information associated with one or more products, data sparsity, or sales trends. As referenced herein, the data 116 is captured from one or more structured datasets associated with products, data scarcity, and sales trends that are obtained from one or more APIs, cloud shares, secure FTP, and email attachments (formats like JSON, XML, and CSV), as well as external datasets including additional data such as weather, demographics, and holiday calendars. Product data may include sales data, inventory data, shipping data, promotional data, and so forth on a national level, state level, city or county level, and/or store level. In some examples, the data capture tool 122 stores the captured data 116 in a data lake in the data storage device 114. The data lake serves as an immutable staging area, maintains data fidelity, lineage, and atomicity, consistency, isolation, and durability (ACID) compliance for reliable downstream transformation.

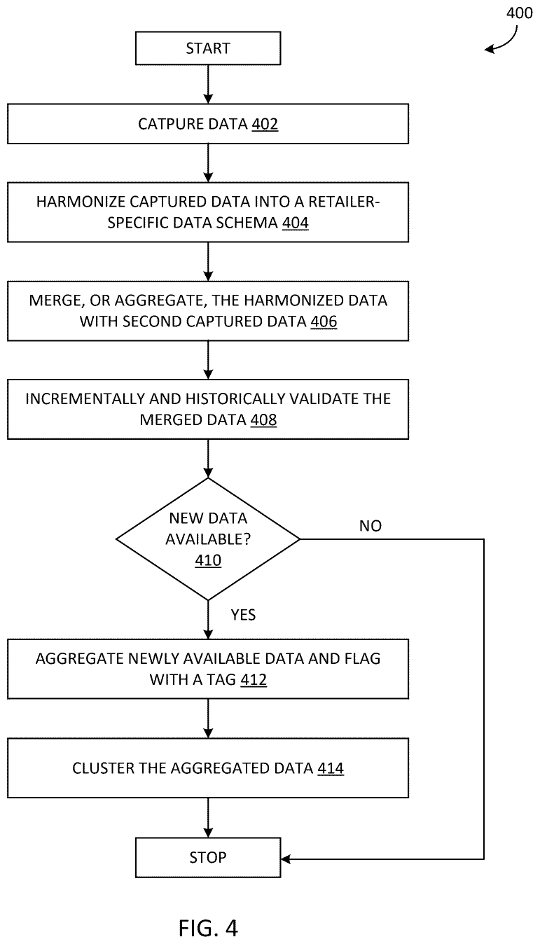

In operation 304, the data processing tool 120 pre-processes the captured data. The process of pre-processing the captured data is described in greater detail below with regards to FIG. 4. In operation 306, the series classifier 134 determining a classification for the one or more products for which the data was captured in operation 302. The determined classification is based at least on one or more of data sparsity and sales trends for the one or more products. In some examples, determining the classification for a product of the one or more products includes comprises placing the product, into a category based on the amount of data available for the product. In some examples, the category is selected from a first category comprising products with a first level of weekly data that is modeled at an item-store level, a second category comprising products with a second level of weekly data, less than the first level of data, that is modeled at a sub-category store level, a third category comprising product with a third level of data, less than the second level of data, that is modeled at a category store level, a fourth category comprising product with a fourth level of data, less than the third level of data, modeled at a category national level, a fifth category comprising products with a fifth level of weekly data, less than the fourth level of data, and a sixth category comprising products that are new with a sixth level of data, less than the fifth level of weekly data.

In operation 308, the day-level forecaster 136 generates a day-level forecast for the one or more classified products. In some examples, generating the day-level forecast includes implementing a plurality of artificial intelligence (AI) models to capture patterns of data based on the classification and/or diverse needs of the one or more products. In particular, the day-level forecaster 136 applies tailored models and customized feature engineering to each product category to manage and evaluate various sales patterns, seasonality, and trends by. Forecasted values enable the creation of a measurement framework for different KPIs and may be used as guiding values to create rule-based alert systems, such as those implemented by the alert system 138 described below, to collect labels initially before building ML-based alert systems.

In operation 310, the alert system 138 generates an alert associated with the one or more forecasted products. In some examples, the generated alert indicates an on-shelf availability (OSA) issue with the one or more products. To generate the alert, the alert system 138 analyzes one or more of a historical sale trend, seasonality data, promotional data, forecast demand data, delivery schedule data, and lead time data, and, based on the analysis, generates a prediction of a time an inventory level of the one or more products will drop below a threshold.

In operation 312, the generated alert is output. In some examples, the generated alert is output on the user interface device 110. In some examples, the generated alert is transmitted to the external device 140 via the communications interface device 112 and presented on the interface 142 of the external device 140.

In operation 314, the forecasting tool 132 determines whether an input is received in response to the output generated alert. Non-limiting examples of inputs received in response to the output generated alert include Confirmed On Hand Discrepancy, Restocked from backroom or top stock, Confirmed out of stock—inventory in transit, Confirmed out of stock—Requested Manual Order, Item on shelf, Plug Fixed (Wrong item in location), or Printed shelf tag. In other words, a received input in response to the output generated alert indicates an accuracy of the generated alert and an action taken in response, if any. In examples where an input is received at operation 314, the computer-implemented method 300 proceeds to operation 316 and the day-level forecaster 136 is updated through a feedback loop that passes on the input in order to further train the day-level forecaster 136 to make more accurate forecasts in the future. Following operation 316, and in examples where an input is not received at operation 314, the computer-implemented method 300 terminates.

FIG. 4 illustrates a computer-implemented method of pre-processing data for an on-shelf availability forecast system according to an example. The computer-implemented method 400 is presented for illustration only and should not be construed as limiting. Other examples of the computer-implemented method 400 can be used without departing from the scope of the present disclosure. The computer-implemented method 400 can be implemented by one or more electronic devices described herein, such as the computing device 102.

The computer-implemented method 400 begins by the data capture tool 122 capturing data in operation 402. The captured data includes at least information associated with one or more products, data sparsity, or sales trends. As referenced herein, the data 116 is captured from one or more structured datasets associated with products, data scarcity, and sales trends that are obtained from one or more APIs, cloud shares, secure FTP, and email attachments (formats like JSON, XML, and CSV), as well as external datasets including additional data such as weather, demographics, and holiday calendars. Product data may include sales data, inventory data, shipping data, promotional data, and so forth on a national level, state level, city or county level, and/or store level. In some examples, the data capture tool 122 stores the captured data 116 in a data lake in the data storage device 114. The data lake serves as an immutable staging area, maintains data fidelity, lineage, and atomicity, consistency, isolation, and durability (ACID) compliance for reliable downstream transformation.

In operation 404, the first data processing tool 124 harmonizes the captured data into a retailer-specific data schema. For example, the harmonized data includes standardized entities that themselves include at least one of a point of sale (POS), inventory, or item master. This enables flexibility while preserving retailer granularity for tailored downstream processes. In some examples, the first data processing tool 124 is referred to as a harmonization tool or a harmonization layer.

In operation 406, the second data processing tool 126 merges, or aggregates, the harmonized data with second, or additional, captured data. As referenced herein, the additional captured data includes at least one of weather data, demographics data, or calendar data. In some examples, the consolidation occurs at the country level to provide broader context for regional analysis. In other examples, the consolidation occurs at the regional, state, or store level. Accordingly, the metadata-driven design of the second data processing tool 126 enables flexible, reusable data models that enhance scalability and performance.

In operation 408, the data validation tool 128 incrementally and historically validates the merged data. For example, the data validation tool 128 incrementally validates the merged data to detect data discrepancies and historically validates the merged data to determine long-term data trends. Incremental validation enables early detection of data discrepancies to prevent propagation of errors. Historical validation enables consistency of long-term data trends for accurate analysis. In operation 410, the data validation tool 128 determines whether new data is available. For example, the data validation tool 128 determines whether the data capture tool 122 has captured additional data. In examples where new data is not available, the computer-implemented method 400 terminates.

In examples where new data is available, the computer-implemented method 400 proceeds to operation 412 and the data validation tool 128 aggregates the newly available data and enriches the aggregated data with business-specific flags, simplifying downstream processing for machine learning models and business intelligence tools. In operation 414, the data scaler and optimizer 130 clusters the aggregated data. In some examples, clusters are automatically scaled to manage large data volumes dynamically, ensuring cost-efficient performance, while event-driven processing enables asynchronous data handling for retailer-specific pipelines. In some examples, the pushing down of queries and liquid clustering improve query efficiency. Following operation 414, the computer-implemented method 400 terminates.

### Results

FIG. 5 a graph illustrating true OSA issue percentage over artificial intelligence (AI) systems alerts probability score. In particular, FIG. 5 illustrates that when the alert fusion system generates an alert, indicating there is an OSA issue for an item in a store, with a probability score of 0.975 or more, 81% of those alerts turned out to be actual OSA issues in the retail stores.

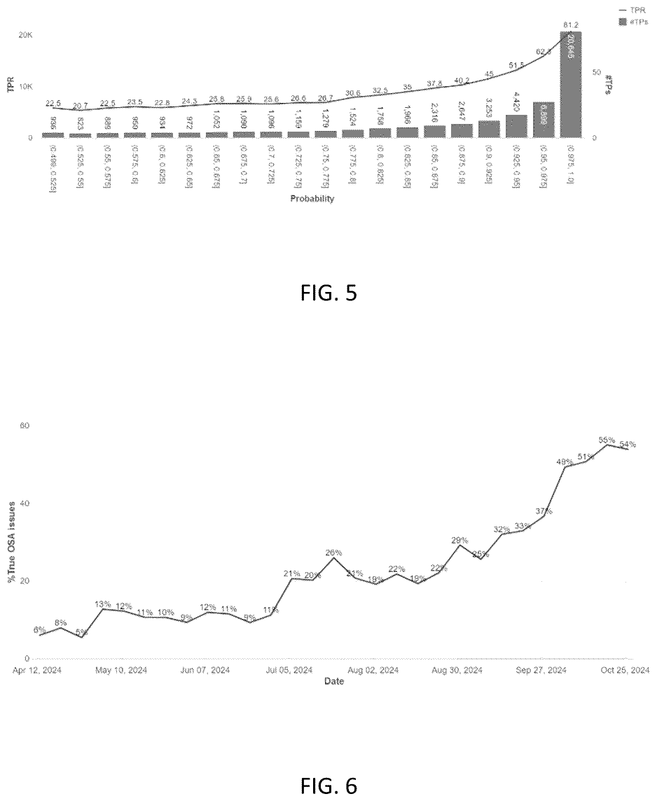

FIG. 6 is a graph illustrating true OSA issues percentage over time with continuous learning. In particular, FIG. 6 illustrates the ability of the system to continuously learn from data improving over time in correctly identifying OSA issues. Starting with a mere ~10% of accurately identifying a true OSA issue during initial alerts based on limited labelled data and random alerts, the system learns with time and has grown into a 5x more accurate system.

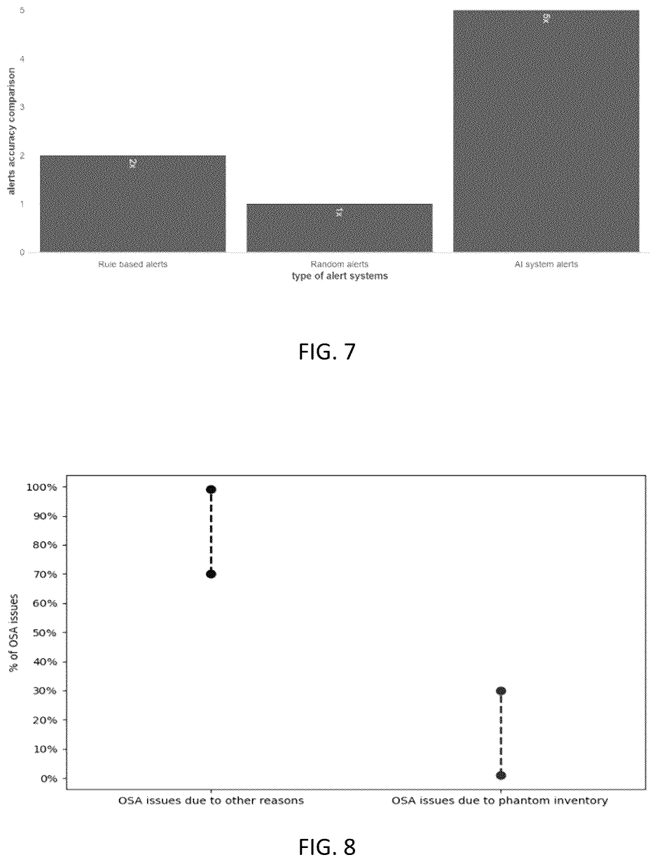

FIG. 7 is a graph illustrating accuracy comparisons of OSA alert systems. In particular, FIG. 7 illustrates a comparison of different alert systems that have been explored with various retailers and their ability to accurately identify an OSA issue. Although random alerts help create an unbiased sample to train the AI alert system, they are not accurate enough due to the presence of numerous item-store combinations and limited on-field broker time. Rule-based systems designed on forecasted values are twice as accurate as random alerts. In contrast, the systems and methods of the present disclosure are five times more accurate and continues to evolve in terms of accuracy.

FIG. 8 is a graph illustrating percentage of OSA issues due to phantom inventory. In particular, FIG. 8 illustrates a proportion of OSA issues potentially due to phantom inventory. OSA issues can occur due to a wide variety of reasons and through the systems and methods of the present disclosure, which leverages the on-field broker responses to learn, among all OSA issues, 1%-30% of the OSA issues are due to phantom inventory across different retailers over different time periods.

In conclusion, addressing on-shelf availability and phantom inventory challenges remains pivotal for retail success, as delays in restocking, misplaced inventory or incorrect system inventory can lead to significant revenue losses despite sufficient stock levels. The scalable, AI-powered solution presented herein effectively counters these inefficiencies by leveraging advanced ML models and distributed cloud processing. Integrating a heterogeneous ensemble of forecasting models—from statistical methods to sophisticated ML techniques—and an adaptive alert fusion system, the solution detects and flags potential disruptions in shelf availability and phantom inventory. This proactive approach ensures timely interventions by field brokers, fostering a continuous improvement loop that enhances system accuracy and adaptability.

### Example Operating Environment

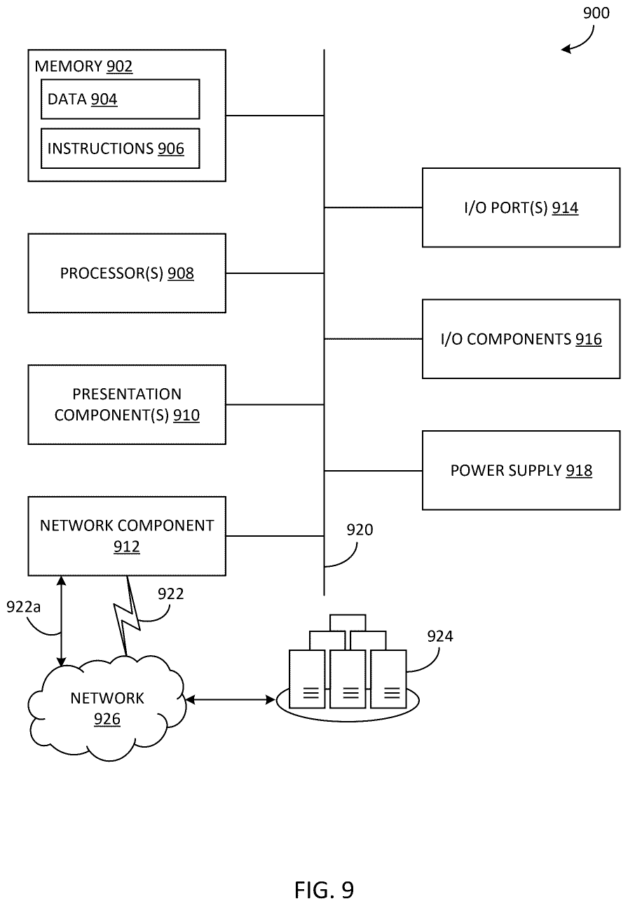

FIG. 9 is a block diagram of an example computing device 900 for implementing aspects disclosed herein and is designated generally as computing device 900. Computing device 900 is an example of a suitable computing environment and is not intended to suggest any limitation as to the scope of use or functionality of the examples disclosed herein. Neither should computing device 900 be interpreted as having any dependency or requirement relating to any one or combination of components/modules illustrated. The examples disclosed herein may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing devices, etc. The disclosed examples may also be practiced in distributed computing environments when tasks are performed by remote-processing devices that are linked through a communications network.

Computing device 900 includes a bus 920 that directly or indirectly couples the following devices: computer-storage memory 902, one or more processors 908, one or more presentation components 910, I/O ports 914, I/O components 916, a power supply 918, and a network component 912. While computing device 900 is depicted as a seemingly single device, multiple computing devices 900 may work together and share the depicted device resources. For example, memory 902 may be distributed across multiple devices, and processor(s) 908 may be housed with different devices.

Bus 920 represents what may be one or more busses (such as an address bus, data bus, or a combination thereof). Although the various blocks of FIG. 9 are shown with lines for the sake of clarity, delineating various components may be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 9 and the references herein to a “computing device.” Memory 902 may take the form of the computer-storage media references below and operatively provide storage of computer-readable instructions, data structures, program modules and other data for computing device 900. In some examples, memory 902 stores one or more of an operating system, a universal application platform, or other program modules and program data. Memory 902 is thus able to store and access data 904 and instructions 906 that are executable by processor 908 and configured to carry out the various operations disclosed herein.

In some examples, memory 902 includes computer-storage media in the form of volatile and/or nonvolatile memory, removable or non-removable memory, data disks in virtual environments, or a combination thereof. Memory 902 may include any quantity of memory associated with or accessible by computing device 900. Memory 902 may be internal to computing device 900 (as shown in FIG. 9), external to computing device 900, or both. Examples of memory 902 include, without limitation, random access memory (RAM); read only memory (ROM); electronically erasable programmable read only memory (EEPROM); flash memory or other memory technologies; CD-ROM, digital versatile disks (DVDs) or other optical or holographic media; magnetic cassettes, magnetic tape, magnetic disk storage or other magnetic storage devices; memory wired into an analog computing device; or any other medium for encoding desired information and for access by computing device 900. Additionally, or alternatively, memory 902 may be distributed across multiple computing devices 900, for example, in a virtualized environment in which instruction processing is carried out on multiple computing devices 900. For the purposes of this disclosure, “computer storage media,” “computer-storage memory,” “memory,” and “memory devices” are synonymous terms for computer-storage memory 902, and none of these terms include carrier waves or propagating signaling.

Processor(s) 908 may include any quantity of processing units that read data from various entities, such as memory 902 or I/O components 916 and may include CPUs and/or GPUs. Specifically, processor(s) 908 are programmed to execute computer-executable instructions for implementing aspects of the disclosure. The instructions may be performed by the processor, by multiple processors within computing device 900, or by a processor external to client computing device 900. In some examples, processor(s) 908 are programmed to execute instructions such as those illustrated in the in the accompanying drawings. Moreover, in some examples, processor(s) 908 represent an implementation of analog techniques to perform the operations described herein. For example, the operations may be performed by an analog client computing device 900 and/or a digital client computing device 900. Presentation component(s) 910 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 900, across a wired connection, or in other ways. I/O ports 914 allow computing device 900 to be logically coupled to other devices including I/O components 916, some of which may be built in. Example I/O components 916 include, for example but without limitation, a microphone, joystick, game pad, satellite dish, scanner, printer, wireless device, etc.

Computing device 900 may operate in a networked environment via network component 912 using logical connections to one or more remote computers. In some examples, network component 912 includes a network interface card and/or computer-executable instructions (e.g., a driver) for operating the network interface card. Communication between computing device 900 and other devices may occur using any protocol or mechanism over any wired or wireless connection. In some examples, network component 912 is operable to communicate data over public, private, or hybrid (public and private) using a transfer protocol, between devices wirelessly using short range communication technologies (e.g., near-field communication (NFC), Bluetooths™ branded communications, or the like), or a combination thereof. Network component 912 communicates over wireless communication link 922 and/or a wired communication link 922a to a cloud resource 924 across network 926. Various different examples of communication links 922 and 922a include a wireless connection, a wired connection, and/or a dedicated link, and in some examples, at least a portion is routed through the internet.

Although described in connection with an example computing device 900, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and are non-transitory, i.e., exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

In some examples, a computer-implemented method includes determining a classification for one or more products, wherein the classification is determined based on one or more of data sparsity and sales trends; generating, based on the determined classification, a day-level forecast for the classified one or more products; generating, based on the generated day-level forecast, an alert associated with the forecasted one or more products, the generated alert indicating an on-shelf availability (OSA) issue with the one or more products; and outputting the generated alert.

In some examples, a system comprises a memory and a processor coupled to the memory. The processor is configured to capture data from one or more structured datasets, wherein the captured data includes at least information associated with the one or more products, the data sparsity, and the sales trends; and pre-process the captured data; determine a classification for one or more products, wherein the classification is determined based on one or more of data sparsity and sales trends; generate, based on the determined classification, a day-level forecast for the classified one or more products; generate, based on the generated day-level forecast, an alert associated with the forecasted one or more products, the generated alert indicating an on-shelf availability (OSA) issue with the one or more products; and output the generated alert.

In some examples, one or more non-transitory computer readable media storing instructions that, when executed by a processor, cause the processor to capture data from one or more structured datasets, wherein the captured data includes at least information associated with the one or more products, the data sparsity, and the sales trends; harmonize the captured data into a retailer-specific data schema, wherein the harmonized data includes standardized entities, and wherein the standardized entities include at least one of a point of sale (POS), inventory, or item master; merge the harmonized data with second captured data, the second captured data including at least one of weather data, demographics data, or calendar data; determine a classification for one or more products, wherein the classification is determined based on one or more of data sparsity and sales trends; generate, based on the determined classification, a day-level forecast for the classified one or more products; generate, based on the generated day-level forecast, an alert associated with the forecasted one or more products, the generated alert indicating an on-shelf availability (OSA) issue with the one or more products; and output the generated alert.

Further examples are described herein.

Various examples further include one or more of the following:
wherein the one or more products includes a portfolio of products;
further comprising generating, based on the day-level forecast, a measurement framework for one or more key performance indicators (KPIs);
wherein the generated alert is one or more of a random alert, a high-priority alert, or a machine learning (ML) alert;
further comprising: capturing data from one or more structured datasets, wherein the captured data includes at least information associated with the one or more products, the data sparsity, and the sales trends; and pre-processing the captured data from the captured one or more structured datasets;
wherein the pre-processing data from the captured one or more structured datasets further comprises harmonizing the captured data into a retailer-specific data schema, wherein the harmonized data includes standardized entities, and wherein the standardized entities include at least one of a point of sale (POS), inventory, or item master;
wherein the pre-processing data from the captured one or more structured datasets further comprises merging the harmonized data with second captured data, the second captured data including at least one of weather data, demographics data, or calendar data;
wherein the pre-processing data from the captured one or more structured datasets further comprises: incrementally validating the merged data to detect data discrepancies; historically validating the merged data to determine long-term data trends; and aggregating, at a regular interval, newly available data and flagging the aggregated data with a tag;
wherein the pre-processing data from the captured one or more structured datasets further comprises clustering the aggregated data;
wherein determining the classification for the one or more products further comprises placing each product, of the one or more products, into a category based on an amount of data available for the product;
wherein the category is selected from a first category comprising products with a first level of weekly data that is modeled at an item-store level, a second category comprising products with a second level of weekly data, less than the first level of data, that is modeled at a sub-category store level, a third category comprising product with a third level of data, less than the second level of data, that is modeled at a category store level, a fourth category comprising product with a fourth level of data, less than the third level of data, modeled at a category national level, a fifth category comprising products with a fifth level of weekly data, less than the fourth level of data, and a sixth category comprising products that are new with a sixth level of data, less than the fifth level of weekly data;
wherein generating the day-level forecast further comprises implementing a plurality of artificial intelligence (AI) models to capture patterns of data based on the classification for the one or more products; and
wherein generating the alert associated with the one or more products further comprises: analyzing one or more of a historical sale trend, seasonality data, promotional data, forecast demand data, delivery schedule data, and lead time data; and based on the analysis, generating a prediction of a time an inventory level of the one or more products will drop below a threshold.

The order of execution or performance of the operations in examples of the disclosure illustrated and described herein is not essential, and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A computer-implemented method comprising:
determining a classification for one or more products, wherein the classification is determined based on one or more of data sparsity and sales trends;
generating, based on the determined classification, a day-level forecast for the classified one or more products;
generating, based on the generated day-level forecast, an alert associated with the forecasted one or more products, the generated alert indicating an on-shelf availability (OSA) issue with the one or more products; and
outputting the generated alert.

2. The computer-implemented method of claim 1, wherein the one or more products includes a portfolio of products.

3. The computer-implemented method of claim 1, further comprising generating, based on the day-level forecast, a measurement framework for one or more key performance indicators (KPIs).

4. The computer-implemented method of claim 1, wherein the generated alert is one or more of a random alert, a high-priority alert, or a machine learning (ML) alert.

5. The computer-implemented method of claim 1, further comprising:
capturing data from one or more structured datasets, wherein the captured data includes at least information associated with the one or more products, the data sparsity, and the sales trends; and
pre-processing the captured data from the captured one or more structured datasets.

6. The computer-implemented method of claim 5, wherein the pre-processing data from the captured one or more structured datasets further comprises:
harmonizing the captured data into a retailer-specific data schema, wherein the harmonized data includes standardized entities, and wherein the standardized entities include at least one of a point of sale (POS), inventory, or item master.

7. The computer-implemented method of claim 6, wherein the pre-processing data from the captured one or more structured datasets further comprises:
merging the harmonized data with second captured data, the second captured data including at least one of weather data, demographics data, or calendar data.

8. The computer-implemented method of claim 7, wherein the pre-processing data from the captured one or more structured datasets further comprises:
incrementally validating the merged data to detect data discrepancies;
historically validating the merged data to determine long-term data trends; and
aggregating, at a regular interval, newly available data and flagging the aggregated data with a tag.

9. The computer-implemented method of claim 8, wherein the pre-processing data from the captured one or more structured datasets further comprises clustering the aggregated data.

10. The computer-implemented method of claim 1, wherein determining the classification for the one or more products further comprises placing each product, of the one or more products, into a category based on an amount of data available for the product.

11. The computer-implemented method of claim 10, wherein the category is selected from a first category comprising products with a first level of weekly data that is modeled at an item-store level, a second category comprising products with a second level of weekly data, less than the first level of data, that is modeled at a sub-category store level, a third category comprising product with a third level of data, less than the second level of data, that is modeled at a category store level, a fourth category comprising product with a fourth level of data, less than the third level of data, modeled at a category national level, a fifth category comprising products with a fifth level of weekly data, less than the fourth level of data, and a sixth category comprising products that are new with a sixth level of data, less than the fifth level of weekly data.

12. The computer-implemented method of claim 1, wherein generating the day-level forecast further comprises implementing a plurality of artificial intelligence (AI) models to capture patterns of data based on the classification for the one or more products.

13. The computer-implemented method of claim 1, wherein generating the alert associated with the one or more products further comprises:
analyzing one or more of a historical sale trend, seasonality data, promotional data, forecast demand data, delivery schedule data, and lead time data; and
based on the analysis, generating a prediction of a time an inventory level of the one or more products will drop below a threshold.

14. A system, comprising:
a memory; and
a processor coupled to the memory and configured to:
capture data from one or more structured datasets, wherein the captured data includes at least information associated with one or more products, data sparsity, and sales trends; and
pre-process the captured data;
determine a classification for the one or more products, wherein the classification is determined based on one or more of the data sparsity and the sales trends;
generate, based on the determined classification, a day-level forecast for the classified one or more products;
generate, based on the generated day-level forecast, an alert associated with the forecasted one or more products, the generated alert indicating an on-shelf availability (OSA) issue with the one or more products; and
output the generated alert.

15. The system of claim 14, wherein, to pre-process the data, the processor is further configured to:
harmonize the captured data into a retailer-specific data schema, wherein the harmonized data includes standardized entities, and wherein the standardized entities include at least one of a point of sale (POS), inventory, or item master; and
merge the harmonized data with second captured data, the second captured data including at least one of weather data, demographics data, or calendar data.

16. The system of claim 15, wherein, to pre-processor the data, the processor is further configured to:
incrementally validate the merged data to detect data discrepancies;
historically validate the merged data to determine long-term data trends;
aggregate, at a regular interval, newly available data and flagging the aggregated data with a tag; and
cluster the aggregated data.

17. The system of claim 14, wherein, to determine the classification for the one or more products, the processor is further configured to:
place each product, of the one or more products, into a category based on an amount of data available for the product,
wherein the category is selected from a first category comprising products with a first level of weekly data that is modeled at an item-store level, a second category comprising products with a second level of weekly data, less than the first level of data, that is modeled at a sub-category store level, a third category comprising product with a third level of data, less than the second level of data, that is modeled at a category store level, a fourth category comprising product with a fourth level of data, less than the third level of data, modeled at a category national level, a fifth category comprising products with a fifth level of weekly data, less than the fourth level of data, and a sixth category comprising products that are new with a sixth level of data, less than the fifth level of weekly data.

18. The system of claim 14, wherein, to generate the alert associated with the one or more products, the processor is further configured to:
analyze one or more of a historical sale trend, seasonality data, promotional data, forecast demand data, delivery schedule data, and lead time data; and
based on the analysis, generate a prediction of a time an inventory level of the one or more products will drop below a threshold.

19. One or more non-transitory computer readable media storing instructions that, when executed by a processor, cause the processor to:
capture data from one or more structured datasets, wherein the captured data includes at least information associated with one or more products, data sparsity, and sales trends;
harmonize the captured data into a retailer-specific data schema, wherein the harmonized data includes standardized entities, and wherein the standardized entities include at least one of a point of sale (POS), inventory, or item master;
merge the harmonized data with second captured data, the second captured data including at least one of weather data, demographics data, or calendar data;
determine a classification for the one or more products, wherein the classification is determined based on one or more of the data sparsity and the sales trends;
generate, based on the determined classification, a day-level forecast for the classified one or more products;
generate, based on the generated day-level forecast, an alert associated with the forecasted one or more products, the generated alert indicating an on-shelf availability (OSA) issue with the one or more products; and
output the generated alert.

20. The one or more non-transitory computer readable media of claim 19, further storing instructions that, when executed by the processor, cause the processor to:
wherein, to determine the classification for the one or more products, the processor is further configured to:
place each product, of the one or more products, into a category based on an amount of data available for the product,
wherein the category is selected from a first category comprising products with a first level of weekly data that is modeled at an item-store level, a second category comprising products with a second level of weekly data, less than the first level of data, that is modeled at a sub-category store level, a third category comprising product with a third level of data, less than the second level of data, that is modeled at a category store level, a fourth category comprising product with a fourth level of data, less than the third level of data, modeled at a category national level, a fifth category comprising products with a fifth level of weekly data, less than the fourth level of data, and a sixth category comprising products that are new with a sixth level of data, less than the fifth level of weekly data.
